(19) United States
(12) Patent Application Publication
(10) Pub. No.: US 2024/0401626 A1
(43) Pub. Date: Dec. 5, 2024

(54) BLIND RIVET WITH CONNECTING HEAD

(71) Applicant: Böllhoff Verbindungstechnik GmbH, Bielefeld (DE)

(72) Inventor: Thorsten RABE, Kalletal (DE)

(21) Appl. No.: 18/732,794

(22) Filed: Jun. 4, 2024

(30) Foreign Application Priority Data
Jun. 5, 2023 (DE) 202023103075.0

(51) Int. Cl. F16B 19/10

(52) U.S. Cl. CPC F16B 19/1054

(57) ABSTRACT

Disclosed is a blind rivet including the following features: a sleeve section which at a fastening end of the sleeve section is expandable with a pulling mandrel, a functional flange which is integrally configured with the sleeve section at a functional end of the sleeve section opposite to the fastening end and which extends radially beyond the sleeve section, and a connecting head which is molded to the functional flange so that a connection between the blind rivet and an add-on part can be established.

### 1. FIELD OF THE INVENTION

The present invention is related to a blind rivet of the known construction with a connecting head as well as a component with a component aperture in which such a blind rivet is arranged.

### 2. BACKGROUND OF THE INVENTION

The basic construction of a blind rivet is known in the state of the art. The blind rivet is comprised of a hollow rivet body, or also called sleeve section, and a breakable pull-through mandrel with head that is arranged in this sleeve section. A closing head of the blind rivet is created by means of a radial expanding of the sleeve section with the help of the pull-through mandrel.

A blind rivet of this construction is for example described in the European patent application EP 2 722 535 A2. The blind rivet is made of a sleeve section at the one end of which the pulling head of the pulling mandrel is arranged. Opposite to the pulling head, a plate-like edge is arranged at the other end of the sleeve section, which forms the end of the sleeve section. This plate-like edge serves for supporting the blind rivet at a component after the sleeve section has been inserted into a component aperture.

Facing away from the sleeve section, a clamping head, which is for example configured as a ball head, threaded pin, threaded bushing or smooth cylindrical pin, is located adjacent to the plate-like edge. The sleeve section as well as the clamping head are equipped with a passage channel which is passed through by the pulling mandrel.

After the inserting of the sleeve section into a component aperture of a component, a pulling force applied on the pulling mandrel generates the formation of a closing head by deforming the sleeve section, causing the blind rivet to be fastened in the component aperture of the component.

A further configuration of a blind rivet is disclosed in EP 2 037 131 A1. Apart from the sleeve section and the closing plate-like edge, the disclosed blind rivet comprises a functional head which is equipped with a radially outer knurling or structuring. This functional head serves for arranging and fastening connecting structures, e.g. a ball head, on the structured surface of the functional head. A disadvantage in this context is that the radially outer knurling is prone to axial pulling forces at the ball head. This leads to a loosening of the connection between functional head and ball head.

With respect to the above discussed state of the art, it is the object of the present invention to suggest an alternative construction of a blind rivet which guarantees an effective fastening in a component aperture of a component as well as a reliable connection of an add-on part.

### 3. SUMMARY OF THE INVENTION

The above object is solved by a blind rivet according to claim 1 as well as a connection of component and blind rivet according to claim 9. Advantageous configurations and further developments result from the following description, the drawings as well as the appending claims.

The present invention provides a blind rivet with the following features: a sleeve section which at a fastening end of the sleeve section is expandable with a pulling mandrel, a functional flange which is integrally configured with the sleeve section at a functional end of the sleeve section opposite to the fastening end and which extends radially beyond the sleeve section, and a connecting head which is molded to the functional flange so that a connection between the blind rivet and an add-on part can be established.

The inventive blind rivet constitutes a multi-functional connecting component, in particular a two-sided connection component. In terms of its basic structure, this multi-functional connecting component is based on the known construction of a blind rivet. This blind rivet is made of the mentioned sleeve section which is expanded with the help of a pulling mandrel, so as to fasten the blind rivet in the aperture of a component in a manner that it cannot be released without being destroyed. Thus, the known blind rivet construction is used for fastening a connection location to a component with a component aperture.

While on the one hand, the fastening end of the deformable sleeve section serves for the fastening in the component aperture, a coupling structure is provided opposite to this fastening end at the functional end of the sleeve section which provides a form-fit or/and a combined form-fit and force-fit connection to an add-on part. This connecting structure, which is for example formed by a ball head, is molded to the sleeve section by means of a fastening flange.

While known blind rivet constructions comprise a separating plate or collar construction between the sleeve section and the connecting section arranged on the side of the pulling mandrel, the inventive sleeve section is characterized by an integrally configured functional flange. This functional flange is arranged on the opposite end of the sleeve section with respect to the fastening end. Due to its structure, which extends radially beyond the sleeve section, a connecting head can be molded to the functional flange.

In this context, molding means that the connecting head is made of a different material than the sleeve section. Additionally, the material of the connecting head encompasses the functional head at least partly in a way that the connecting head is tightly arranged at the functional head. Such an arrangement of a connecting head is preferably achieved by an injection molding method, a gluing method, a dip and cure method or the like.

According to a preferred configuration, the connecting head has a ball-like form, e.g. a complete ball or a hemisphere or a partial ball, so that an add-on part, equipped with a ball socket can be snapped onto this connecting head. If such a connection is releasable or not is dependent on the shape and material selection of the add-on part and in particular on the ball socket integrated there.

According to a further preferred embodiment of the blind rivet, the functional flange is formed disc-like and thereby forms an axial undercut in a longitudinal direction of the sleeve section.

According to the invention, the functional flange is configured similar to a disc which is formed integrally at the functional end of the sleeve section. Independent of the shape of the functional flange, a central aperture is provided in the functional flange, through which the pulling mandrel of the blind rivet extends. The functional flange extends radially beyond the outer edge of the sleeve section due to its disc-like configuration. Due to this, the sleeve section and the functional flange preferably form a T-shaped structure in a lateral view.

Due to the preferred radial extension of the functional flange beyond the radial boundary of the sleeve section, the functional flange preferably forms a contact surface for a component as soon as the sleeve section has been inserted into a component aperture of the component. At the same time, this contact surface constitutes an axial undercut of the combination of sleeve section and functional flange. Due to this axial undercut, the sleeve section with functional flange and thus the blind rivet are held in the component aperture in a form-fit manner before the pulling mandrel radially expands the sleeve section within the component aperture and fastens the blind rivet. After the radial expansion of the sleeve section with the help of the pulling mandrel, the blind rivet is held in the component aperture by clamping at least a part of the edge of the component aperture between the functional flange and the expanded fastening end of the sleeve section.

Preferably, the functional flange of the blind rivet is mushroom-shaped in axial direction of the sleeve section and tapers in the direction of the fastening end of the sleeve section.

As already mentioned above, the connecting head is molded to the functional flange of the blind rivet. The result of the molding is that the connecting head encompasses the functional flange at least at its radial outer sides as well as on the side facing away from the sleeve section. This side which faces away from the sleeve section only comprises the mentioned aperture in order to provide the pulling mandrel for the fastening of the blind rivet. As the functional flange tapers in axial direction to the sleeve section, the connection of functional flange and connecting head forms a form-fit connection, as the removing of the connecting head in the direction facing away from the sleeve section would, due to the mushroom-shaped configuration of the functional flange and its tapering, lead to the connecting head having to be expanded radially. As such a radial expansion comes along with additional mechanical tensions and energy to be applied, the preferred mushroom-shaped configuration provides for a stable and secure retention of the connecting head on the functional flange.

According to a further preferred configuration of the blind rivet, the disc-like functional flange is completely surrounded circumferentially by the connecting head out of plastic material.

According to a preferred configuration of the present invention, the connecting head is injected to the functional flange. Such an injection process is generally known in the state of the art. This will preferably lead to the functional flange being completely enclosed by the connecting head. The only exception is the exit aperture of the pulling mandrel on the side of the connecting head which faces away from the sleeve. A further exception is the side of the functional flange which faces in the direction of the sleeve section.

According to a preferred configuration of the present invention, the functional flange has a contact side facing the sleeve section which is aligned almost perpendicular to the sleeve section. When the blind rivet is fastened in a component aperture, the contact side preferably serves as a contact surface to the component in which the component aperture is arranged.

According to the invention, the connecting head preferably has a fastening side which faces towards the fastening end of the sleeve section and from which at least one embossing or sealing rip projects, which circulates the sleeve section and projects axially beyond the functional flange.

According to the invention, the connecting head preferably comprises the fastening side which is arranged flush with the contact side of the functional flange. Preferably, this causes the fastening side of the connecting head and the contact side of the functional flange to jointly contact the component adjacent to the component aperture, as soon as the blind rivet has been fastened in the component aperture. In this context, the contact surface has the preferred advantage that a block connection between the functional flange and the component with component aperture is formed.

The fastening side of the connecting head which abuts the component is preferably made of plastic material. In order to also provide for a sealing between the component aperture and the blind rivet arranged in there, beside the firm connection between blind rivet and component, it is preferred that circumferentially around the sleeve section, an embossing or sealing rip be provided at the fastening side of the connecting head. This embossing or sealing rip projects from the fastening side and preferably also projects beyond the contact side of the functional flange in the direction of the sleeve section. This construction leads to the embossing or sealing rip being compressed at the abutting component surface with component aperture when the blind rivet is fastened in the component aperture such that a sealing function is realized.

In a further preferred configuration of the inventive blind rivet, its connecting head is configured similar to a double cone with a fastening cone and a connecting cone connected via a tapered neck portion.

In order to be able to use the connecting head in a multifunctional manner, same is configured as a double cone according to a preferred configuration of the invention. This double cone provides the possibility that a ball-like head or a connecting cone, respectively, is arranged in a direction facing away from the sleeve. This connecting cone preferably serves for fastening, preferably for snapping-on, a ball socket or a ball-like socket on this connecting cone.

A fastening cone is provided adjacent to the sleeve section and the functional flange. The fastening cone and the connecting cone are connected with each other by means of a tapering neck portion. Preferably, the double cone forms an integral structure of connecting cone and fastening cone with neck portion lying in between. The preferred fastening cone guarantees that it expands radially in axial direction to the sleeve section, starting at the neck portion. Thus, the fastening cone provides a transversely extending contact surface for the add-on part, which has been connected with the connecting cone, beside the fastening surface adjacent to the component with component aperture. The radially expanding shape of the fastening cone preferably impedes an extensive sliding of the add-on part on the connecting cone.

Preferably, the fastening cone extends radially beyond the functional flange and the connecting cone has a ball-like coupling head.

According to a further preferred embodiment of the present invention, the functional flange of the blind rivet includes at least one step in axial direction, which provides a retention surface, which preferably has a gearing, in the direction of the fastening end of the sleeve section.

In order to reinforce the connection between the connecting head and the functional flange, the functional flange comprises in the direction of the sleeve section a step which is radially offset to the inside. According to a preferred configuration, the functional flange is made of two discs that are arranged upon one another and are integrally connected and have a different diameter, wherein the disc which adjoins the sleeve section has a smaller diameter than the disc which adjoins the connecting head. As a result, the disc which faces away from the sleeve section projects beyond the disc which directly adjoins, thus forming an axial undercut of the functional flange. This axial undercut preferably supports a retention of the connecting head on the functional flange when same is loaded by pulling forces in the direction away from the sleeve section.

According to a further preferred configuration, gearings are provided at this axial undercut which project in the direction of the sleeve section from the step surface. This gearing has the preferred advantage that it retains the connecting head against a rotating at the functional flange.

The present invention furthermore discloses a component, in particular a vehicle body component or carriage component of a motor vehicle with a component aperture in which the blind rivet according to at least one of the above-described configurations is arranged.

According to the invention, it is preferred that an add-on part is arranged at the connecting head of the blind rivet.

### 4. SHORT SUMMARY OF THE DRAWINGS

In the following, the present invention will be described in detail with reference to the drawings. In the drawings, the same reference signs denote the same components and/or elements. They show:

FIG. 1 a perspective view of a preferred embodiment of the inventive blind rivet with connecting head in the non-set state,

FIG. 2 a lateral view of a preferred embodiment of the inventive blind rivet with connecting head in the non-set state,

FIG. 3 a preferred configuration of the inventive blind rivet with connecting head in a lateral view in the non-set state,

FIG. 4 an axial view of the blind rivet with connecting head according to FIG. 3 from the direction of the sleeve section,

FIG. 5 a preferred enlarged view of the sleeve section with functional flange without connecting head in a lateral representation,

FIG. 6 a preferred embodiment of the blind rivet in a non-set state without inventively preferred connecting head,

FIG. 7 a perspective view of the blind rivet in the non-set state without connecting head,

FIG. 8 a schematic view of the inventive blind rivet arranged in a component aperture of a component with an add-on part fastened to the connecting head and

FIG. 9 a schematic view of the inventive blind rivet set in a component aperture of a component with an add-on part fastened to the connecting head.

### 5. DETAILED DESCRIPTION OF PREFERRED EMBODIMENTS

A perspective illustration of a preferred embodiment of the inventive blind rivet 1 is shown in FIG. 1. The blind rivet 1 in the non-set state is schematically illustrated. This means that a sleeve section 10 is not arranged and widened in a component aperture O of a component B.

In the hollow cylindrically configured sleeve section 10, a pulling mandrel 20 is arranged axially movably. The pulling mandrel 20 has a pulling head 22 adjacent to the sleeve section 10. The pulling head 22 has an outer diameter which is configured larger than an inner diameter of a passage channel of the sleeve section 10. If the pulling head 22 is pulled into the sleeve section 10 with the help of the pulling mandrel 20, the sleeve section 10 is radially widened by that and a closing head 16 is formed.

The pulling head 22 is drawn into a fastening end 12 of the sleeve section 10 for the purpose of fastening the blind rivet 1 in the component aperture O. The sleeve section 10 is connected with a connecting head 50. The connecting head 50 is adapted so as to establish a connection with an add-on part A, e.g. a vehicle light, a cladding part, an interior paneling or an insulating part.

In order to carry out this function, the connecting head 50 has a coupling head 52 at least in a direction facing axially away from the sleeve section 10. The coupling head 52 is preferably configured ball-like, hemispherical, ellipsoidal, cone-like or truncated cone-like.

According to a preferred embodiment of the present invention, the connecting head 50 is firmly connected with the sleeve section 10. For this purpose, the sleeve section 10 has a functional flange 30 which is integrally configured with the sleeve section 10 at a functional end 14 of the sleeve section 10.

Preferably, the connecting head 50 is injected to the functional flange 30, preferably with a common injection molding method.

For establishing the connection between the coupling head 52 and the add-on part A, the coupling head 52 preferably snaps into a ball socket or a similar construction at the add-on part A. Before that, the sleeve section 10 was expanded by pulling the pulling head 22 in the direction of the connecting head 50, connected with same in the component aperture O and the pulling mandrel 20 was removed from the sleeve section 10. Accordingly, the coupling head 52 is free so as to be connected with the add-on part A (see FIG. 9).

According to a preferred configuration of the present invention, the connecting head 50 only comprises a coupling head 52 (see above) which is molded to the functional flange 30. The coupling head 52 is sufficient for establishing a connection with the add-on part A. A mechanically loadable and reliable fastening of the coupling head 50 is guaranteed by its molding or injecting to the functional flange 30 which is described further below in more detail.

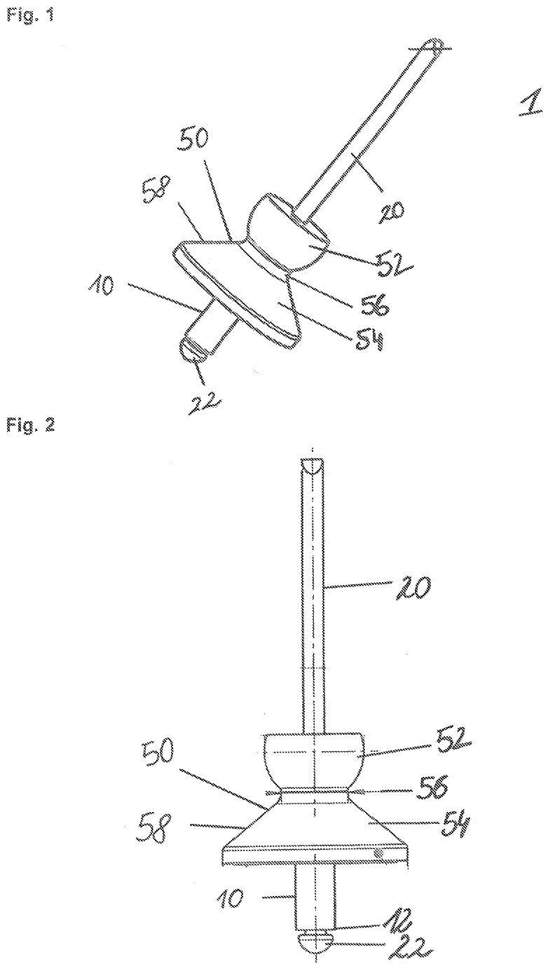

According to a preferred embodiment of the present invention, the connecting head 50 has the form of a double cone, as is for example shown in FIGS. 1-3. The double cone is formed by a fastening cone 54 and a connecting cone, preferably the coupling head 52. The fastening cone 54 and the connecting cone 52 are connected with each other by means of a neck portion 56. Preferably, the coupling head 52 and the fastening cone 54 taper while proceeding towards one another in the direction of the neck portion 56.

Preferably, the fastening cone 54 provides a circumferential radial outer lateral surface 58. Preferably, the lateral surface 58 serves as a support surface for an add-on part A which is arranged on the coupling head 52. The radially expanding design of the fastening cone 54 in the direction of the sleeve section 10 preferably prevents the add-on part A from being slid too far on the coupling head 52. Furthermore, it is also preferred that supporting forces of the add-on part A are diverted via the lateral surface 58 and the fastening cone 54 into the component B which is fastened to the sleeve section 10.

The preferred double cone of the connecting head 50 ends adjacent to the sleeve section 10 preferably in a fastening side 60. In other words, the fastening cone 54 is limited in the direction of the sleeve section 10 by the fastening side 60.

According to a preferred configuration of the present invention, the fastening side 60 is arranged transversely, in particular perpendicularly, to the sleeve section 10. The fastening side 60 forms a contact surface at the component B after the blind rivet 1 has been fastened in the component aperture O.

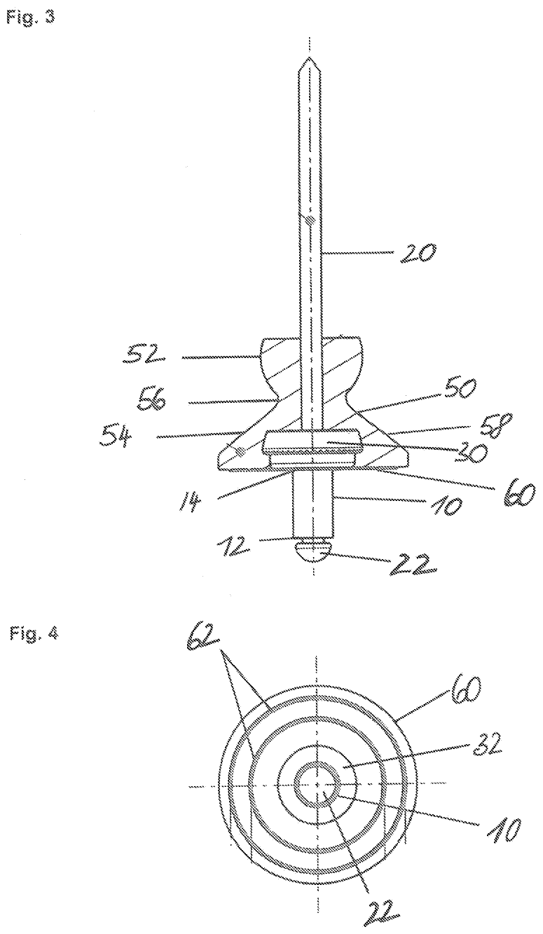

FIG. 4 shows a preferred embodiment of the fastening side 60. It corresponds to a view of the blind rivet 1 of FIG. 3 in axial direction based on the sleeve section 10. In FIG. 4, the pulling head 22 and the wall of the sleeve section 10 circulating the pulling head 22 can be seen in the center of the fastening surface 60.

In a direction radially to the outside, a contact surface 32 of the functional flange 30 follows the sleeve section 10. The contact surface 32 is preferably configured like a ring. It is also preferred that the functional flange 30 and thus also the contact surface 32 are configured non-round, in particular elliptically or multiangled. Preferably, the contact surface 32 forms a direct contact between functional flange 30 and component B after the blind rivet 1 has been fastened in the component aperture O. That way, it is also preferred that a connection on block between the functional flange 30, i.e. the blind rivet 1, and the component B is realized.

The contact surface 60 extends in an annular surface around the contact surface 32. The contact surface 60, which is realized by the connecting head 50, comprises one or a plurality of embossing and/or sealing rips 62. The embossing or sealing rips 62 extend in a circumferential manner, preferably annularly circumferentially, around the contact surface 32 of the functional flange 30. The embossing or sealing rips 62 axially project in the direction of the sleeve section 10 out from the fastening side 60. It is likewise preferred that the embossing or sealing rips 62 project axially beyond the contact surface 32 of the functional flange 30.

According to a further preferred configuration, the embossing rips 62 extend in radial direction on the contact surface 60.

When the blind rivet 1 is fastened at the component B, the embossing or sealing rips are preferably pressed against the component B. That way, the embossing or sealing rips 62 perform a sealing function between the blind rivet 1 with connecting head 50 and its fastening side 60 and the component B.

It is furthermore preferred that the embossing rips 62 emboss into the surface of the component B. That way, the connection between blind rivet 1 and component B is stabilized, preferably against a relative movement between connecting head 50 and component B.

According to a preferred embodiment of the present invention, the connecting head 50 is made of plastic material. This plastic material is molded to the functional flange 30 with the help of a known injection molding method. According to a preferred configuration of the present invention, the connecting head 50 is made of polyamide with a proportion of glass fiber of more than 50%. Other plastic materials with similar characteristics can be used as well.

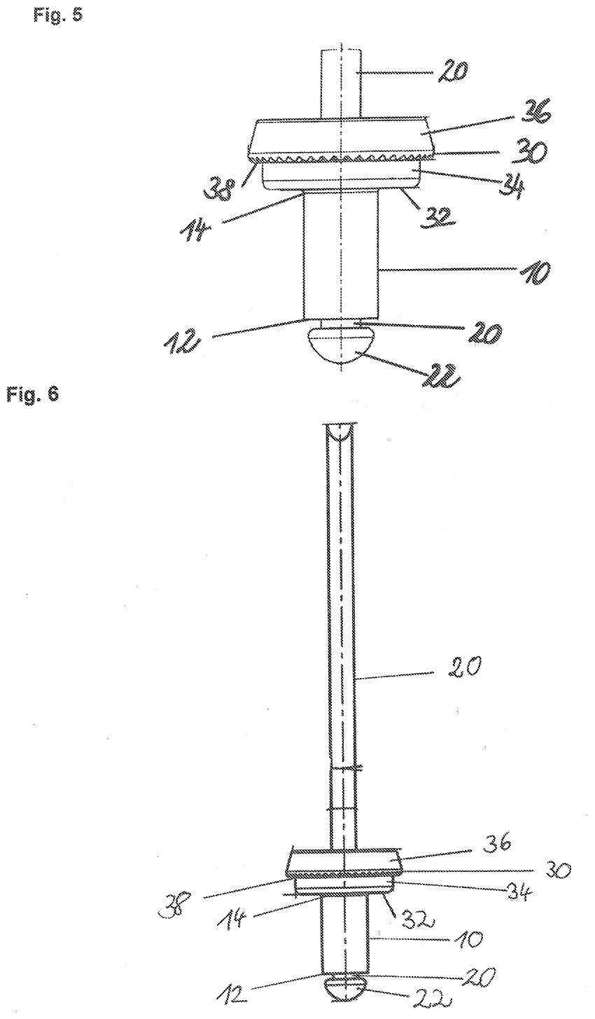

The functional flange 30 which carries the connecting head 50 or double cone is integrally connected with the sleeve section 10 and is shown in an enlarged view in FIG. 5. According to the invention, it is preferred that the functional flange 30 has a T-like form which can be recognized in the lateral view of FIG. 5 together with the sleeve section 10.

It is furthermore preferred that the functional flange 30 is configured like a mushroom. This means that in the direction of the sleeve section 10, the functional flange 30 has a smaller lateral extension than in axial direction facing away from the sleeve section 10.

It is also preferred that the functional flange 30 is constituted of two discs 34, 36 which are integrally connected with each other. The disc 34 which faces the sleeve section 10 has a smaller diameter than the disc 36 which faces away from the sleeve section 10. Due to the preferred differences of the discs 34, 36 in the lateral extension or in the cross section, an undercut 38 or a step in the direction of the longitudinal axis of the sleeve section 10 is generated.

The preferred axial undercut 38 supports and reinforces the form-fit connection between functional flange 30 and the connecting head 50. If for example an attempt is made to release a snap connection between the add-on part A and the coupling head 52 by axially pulling in a direction facing away from the sleeve section 10, the connecting head 50 is additionally retained at the axial undercut 38.

According to a further configuration of the present invention, axially projecting gearings 40 or a knurling is provided at the surface of the axial undercut 38. This gearing 40 preferably engages into the connecting head 50. That way, the gearing 40 realizes an anti-rotation security between the functional flange 30 and the connecting head 50.

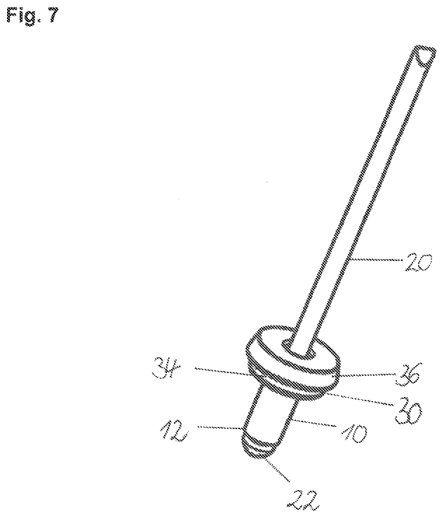

FIG. 6 shows the preferred blind rivet 1 without molded connecting head 50 in a lateral view. FIG. 7 shows the preferred blind rivet 1 without molded connecting head 50 in a perspective lateral view.

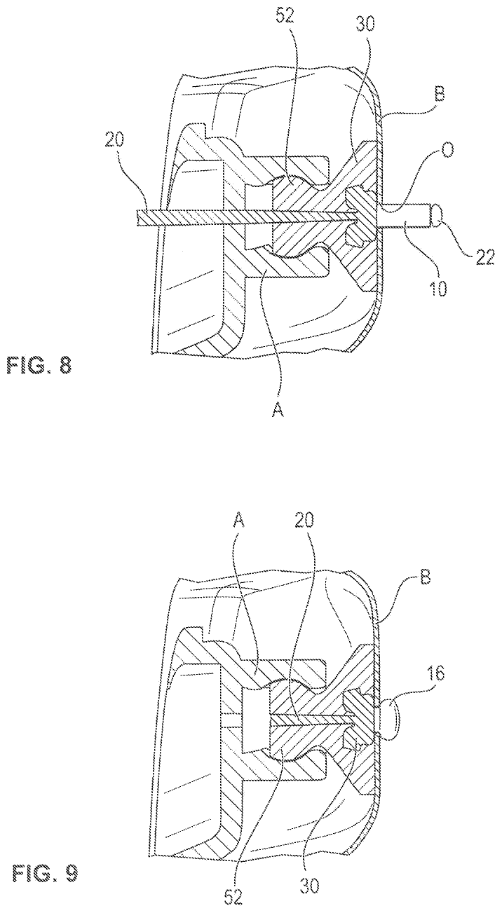

FIG. 8 shows a preferred preliminary stage of a fastening of the blind rivet 1 in the component aperture O of the component B. According to a preferred configuration shown here, the coupling head 52 is first of all connected with the add-on part A. After that, the sleeve section 10 is inserted into the component aperture O. The requirement for that is preferably that the pulling mandrel 20 can extend through the add-on part A.

It is likewise preferred that the blind rivet 1 without add-on part A is arranged in the component aperture O and is fastened there. After that, the add-on part A is connected with the coupling head 52.

For connecting the blind rivet 1 with the component B, pulling force is applied on the pulling mandrel 20. As a result, the pulling head 22 moves into the sleeve section 10 and forms the closing head 16. Furthermore, it is known that the pulling head 20 is demolished or broken off after that.

### 6. LIST OF REFERENCE SIGNS

1 blind rivet
10 sleeve section
12 fastening end
14 functional end
16 closing head of the blind rivet
20 pulling mandrel
22 pulling head
30 functional flange
32 contact surface
34 small disc
36 large disc
38 axial undercut
40 gearing
50 connecting head
52 coupling head
54 fastening cone
56 neck portion
58 lateral surface of the fastening cone
60 fastening side
62 embossing or scaling rips
B component
O component aperture
A add-on part

1. A blind rivet comprising:
a sleeve section which at a fastening end of the sleeve section is expandable with a pulling mandrel,
a functional flange which is integrally configured with the sleeve section at a functional end of the sleeve section opposite to the fastening end and which extends radially beyond the sleeve section, and
a connecting head which is molded to the functional flange so that a connection between the blind rivet and an add-on part can be established.

2. The blind rivet according to claim 1, the functional flange of which is formed disc-like and thereby forms an axial undercut in a longitudinal direction of the sleeve section.

3. The blind rivet according to claim 1, the functional flange of which is mushroom-shaped in an axial direction of the sleeve section and tapers in the direction of the fastening end of the sleeve section.

4. The blind rivet according to claim 2, the disc-like functional flange of which is completely surrounded circumferentially by the connecting head, which comprises a plastic material.

5. The blind rivet according to claim 4, the connecting head of which has a fastening side which faces towards the fastening end of the sleeve section and from which at least one embossing or sealing rip projects, which is configured circumferentially around the sleeve section and axially projects beyond the functional flange.

6. The blind rivet according to claim 1, the connecting head of which is configured similar to a double cone with a fastening cone and a connecting cone connected via a tapered neck portion.

7. The blind rivet according to claim 6, the fastening cone of which extends radially beyond the functional flange and the connecting cone having a ball-like coupling head.

8. The blind rivet according to claim 1, the functional flange of which includes at least one step in an axial direction, which provides a retention surface in the direction of the fastening end of the sleeve section.

9. A component with a component aperture in which the blind rivet according to claim 1 is arranged.

10. The component according to claim 9, wherein an add-on part is arranged at the connecting head of the blind rivet.
